(19) United States
(12) Patent Application Publication
(10) Pub. No.: US 2016/0013674 A1
(43) Pub. Date: Jan. 14, 2016

(54) MOBILE POWER ASSEMBLY

(71) Applicants: Champ Tech Optical (Foshan) Corporation, Foshan (CN); Foxconn Technology Co., Ltd., New Taipei (TW)

(72) Inventors: LONG-QING LIANG, Foshan (CN); DI-QIONG ZHAO, Foshan (CN); CHIH-FENG HU, New Taipei (TW); YUNG-PING LIN, New Taipei (TW)

(21) Appl. No.: 14/526,036

(22) Filed: Oct. 28, 2014

(30) Foreign Application Priority Data
Jul. 11, 2014 (CN) 2014103298262

(51) Int. Cl. H02J 7/00; H02J 7/02

(52) U.S. Cl. CPC H02J 7/0045; H02J 7/025; H02J 7/0047; H02J 7/0072

(57) ABSTRACT

A mobile power assembly includes a battery coupled to a circuit, a signal receiving unit located at a side of the battery and coupled to the circuit, and a signal sending unit located at an opposite side of the battery and coupled to the circuit. The battery is charged by the signal receiving unit receiving signals, and the battery is discharged by the signal sending unit sending signals.

### CROSS-REFERENCE TO RELATED APPLICATIONS

This application claims priority to Chinese Patent Application No. 201410329826.2 filed on Jul. 11, 2014 in the State Intellectual Property Office of the P. R. C, the contents of which are incorporated by reference herein.

### FIELD

The disclosure relates to a mobile power assembly for electrical devices.

### BACKGROUND

A typical mobile power assembly for electrical devices includes housing and a battery received in the housing. The mobile power assembly can be used to charge kinds of electrical devices.

### BRIEF DESCRIPTION OF THE DRAWINGS

Implementations of the present technology will now be described, by way of example only, with reference to the attached figures.

FIG. 1 is a perspective view of a mobile power assembly accordance with an exemplary embodiment of the present disclosure.

FIG. 2 is an inverted view showing a mobile power assembly of FIG. 1.

FIG. 3 is an exploded view of the mobile power assembly of FIG. 1.

FIG. 4 is an exploded view of the mobile power assembly of FIG. 2.

### DETAILED DESCRIPTION OF EMBODIMENTS

It will be appreciated that for simplicity and clarity of illustration, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure. The description is not to be considered as limiting the scope of the embodiments described herein.

Several definitions that apply throughout this disclosure will now be presented. The term “comprising” means “including, but not necessarily limited to”; it specifically indicates open-ended inclusion or membership in a so-described combination, group, series and the like. The term “coupled” is defined as connected, whether directly or indirectly through intervening components, and is not necessarily limited to physical connections. The connection can be such that the objects are permanently connected or releasably connected. The term “electronically coupled” can include any coupling that is via a wired or wireless connection. The electronic coupling can be through one or more components or it can include a direct connection between the described components.

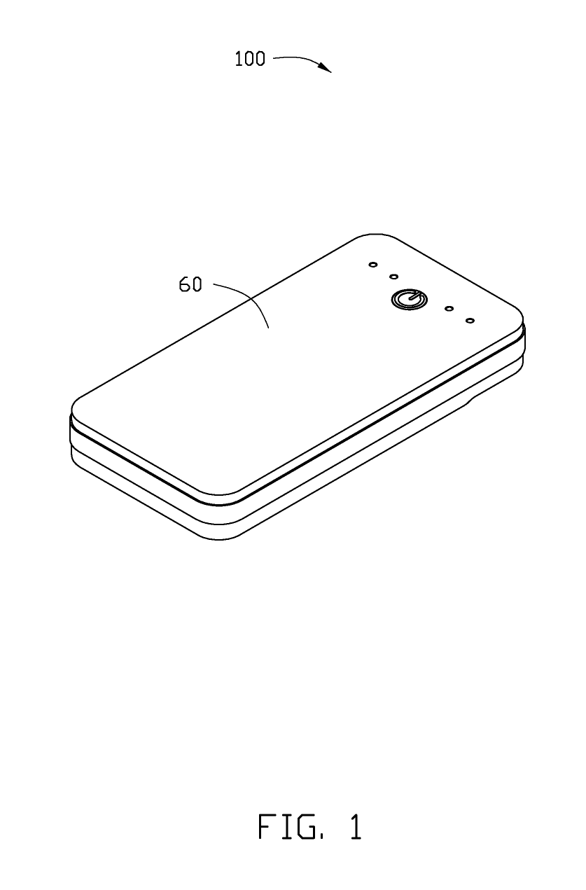

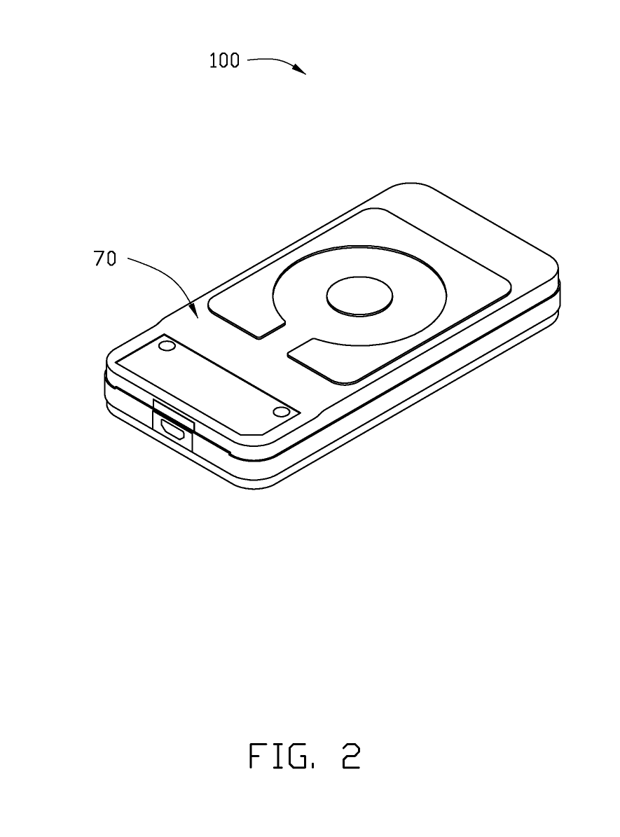

Referring to FIGS. 1-4, the mobile power assembly 100 includes a frame 10, a circuit board 20, a battery 30, a signal receiving unit 40, a signal sending unit 50, a first cover 60 and a second cover 70. The circuit board 20 and the battery 30 are received in the frame 10. The signal receiving unit 40 and the signal sending unit 50 are located at opposite sides of the battery 30 respectively. The first cover 60 and the second cover 70 respectively engage with the frame 10 to house the circuit 20 and the battery 30 in spaces between the first cover 60 and the frame 10, and the second cover 70 and the frame 10.

In at least one embodiment, the frame 10 is rectangular. A port 11 is defined in an end of the frame 10. The port 11 is coupled to the circuit board 20. The port 11 can be used to charge the battery 30, and the port 11 can also be used to output electric energy of the battery 30 to an electrical device coupled to the port 11. In at least one embodiment, the port 11 can be a Universal Serial Bus (USB) port.

The circuit board 20 is received in the frame 10, and is located at an end of the frame 10. Preferably, the circuit board 20 and the port 11 are located at a same end of the frame 10.

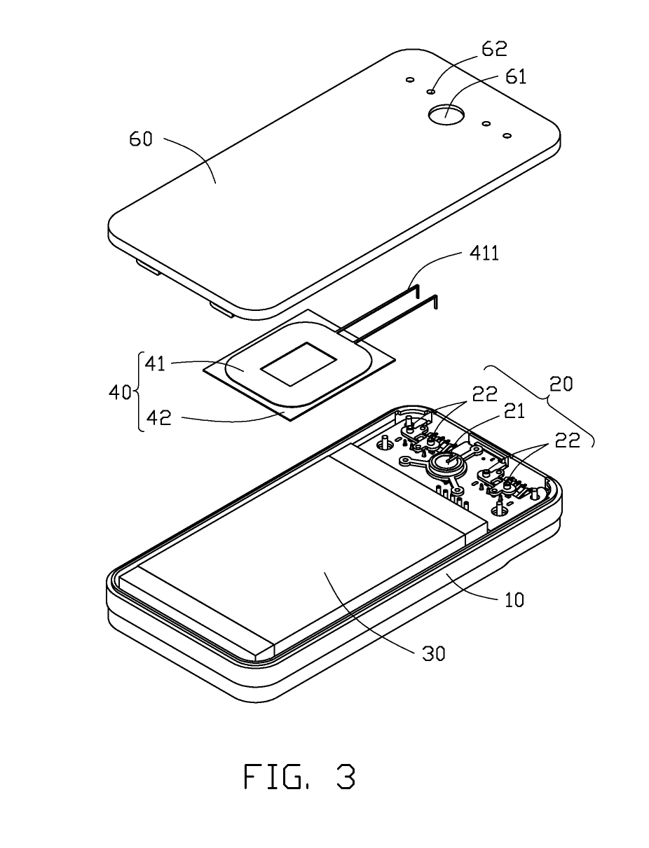

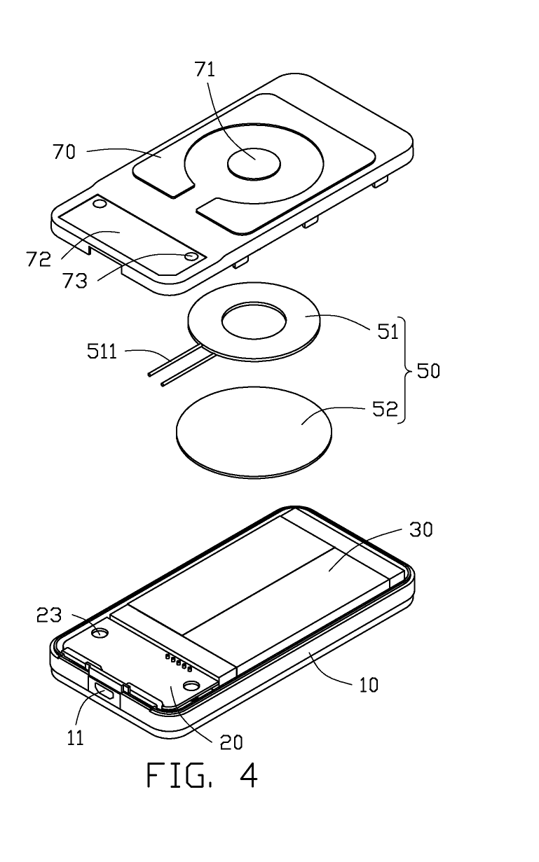

Referring to FIGS. 3-4, a control switch 21 and a plurality of indicators 22 are coupled to a top side of the circuit board 20. The indicators 22 include a plurality of light emitting diodes. A plurality of locking holes 23 are defined in a bottom side of the circuit board 20.

The battery 30 is coupled to the circuit board 20 and stores electric energy from an external power source. The signal receiving unit 40 is located at a top side of the battery 30, and the signal sending unit 50 is located at a bottom side of the battery 30.

The signal receiving unit 40 includes a receiving coil 41 and a spacer 42. The signal receiving unit 40 can be fixed to the top side of the battery 30 by glues or by a way of magnetic adsorption. The receiving coil 41 senses magnetic signals outside to induce currents. The spacer 42 is located between the receiving coil 41 and the battery 30 to optimize magnetic signals received by the receiving coil 41. The receiving coil 41 includes coupling arms 411 coupled to the circuit board 20. The coupling arms 411 conduct the induced currents by the receiving coil 41 to the circuit board 20 to charge the battery 30.

The signal sending unit 50 includes sending coil 51 and a magnetic controlling plate 52. The signal sending unit 50 is fixed to the bottom side of the battery 30. In at least one embodiment, the signal sending unit 50 can be fixed by glues or by a way of magnetic adsorption. Electric energy from the battery 30 can be converted to magnetic signals. The sending coil 51 sends the magnetic signals outside to kinds of electrical devices with wireless-charging function.

The magnetic controlling plate 52 is made of magnetic materials. The magnetic controlling plate 52 is arranged between the sending coil 51 and the battery 30. The magnetic controlling plate 52 optimizes the magnetic signals sent by the sending coil 51 to preferably satisfy different kinds of electrical devices.

The sending coil 51 attaches to the magnetic controlling plate 52. The sending coil 51 includes coupling arms 511 coupled to the circuit board 20. The coupling arms 511 conduct currents from the battery 30 to the sending coil 51.

The first cover 60 is located at an outer side of the signal receiving unit 40. A first through hole 61 and several second through holes 62 are defined in the first cover 60. The first through hole 61 corresponds to the control switch 21. The second through holes 62 correspond to the indicators 22 respectively. In at least one embodiment, the second through holes 62 are defined at opposite sides of the first through hole 61. The control switch 21 is exposed out of the first through hole 61, so that users can operate the control switch 21. The indictors 22 are exposed out of the second through holes 62 to show different status of the mobile power assembly 100.

The second cover 70 is located at an outer side of the signal sending unit 50, and is opposite to the first cover 60. A non-skid plate 71 is arranged at an outer surface of the second cover 70. The non-skid plate 71 corresponds to the signal sending unit 50. When an electrical device with wireless-charging function is located on the second cover 70, the electrical device can be charged and can be maintained by the non-skid plate 71.

A plurality of grooves 72 are defined in a bottom side of the second cover 70 to couple with the frame 10. Plural through holes 73 are defined to correspond with the locking holes 23. Screws can be used to penetrate the through holes 73 and the locking holes 23 to lock the second cover 70 to the frame 10.

In this disclosure, the battery 30 can be charged by a wire-charging way or a wireless-charging way. When the battery 30 is charged by a wire-charging way, a wire is provided to couple with the port 11 of the mobile power assembly 100 to an external power source. When the battery 30 is charged by a wireless-charging way, the battery 30 is charged by the signal receiving unit 40 receiving magnetic signals from an external power source sending magnetic signals.

When the mobile power assembly 100 is discharged, electrical devices can be coupled to the mobile power assembly 100 in a wire-discharging way or in a wireless-charging way. When the mobile power assembly 100 is discharging, an electrical device without wireless-charging function can be coupled to the port 11 of the mobile power assembly 100 by a wire, and an electrical device with wireless-charging function can be charged by the signal sending unit 50.

And in at least one embodiment, the electrical device is placed on the outer surface of the second cover 70, and is maintained by the non-skid plate 71. And then, users control the control switch 21 to charge the electrical device wirelessly. Meanwhile, the indicators 22 indicate the left capacity of the battery 30 in the frame 10.

Alternatively, when the mobile power assembly 100 is charged by a wire-charging way, electrical devices can be charged by the mobile power assembly 100 via a wire-charging way or by a wireless-charging way.

The embodiments shown and described above are only examples. Many details are often found in the art such as the other features of a mobile power assembly. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A mobile power assembly, comprising:
a battery coupled to a circuit;
a signal receiving unit located at a side of the battery and coupled to the circuit, the battery being charged by the signal receiving unit receiving signals; and
a signal sending unit located at an opposite side of the battery and coupled to the circuit, the battery discharging by the signal sending unit sending signals.

2. The mobile power assembly of claim 1, wherein the signal receiving unit comprises receiving coil attached to the side of the battery.

3. The mobile power assembly of claim 2, wherein the signal receiving unit further comprises a spacer located between the battery and the receiving coil.

4. The mobile power assembly of claim 3, wherein the signal sending unit comprises sending coil attached the opposite side of the battery.

5. The mobile power assembly of claim 4, wherein the signal sending unit further comprises a magnetic controlling plate located between the sending coil and the battery.

6. The mobile power assembly of claim 5, wherein the receiving coil comprises coupling arms coupled to the circuit.

7. The mobile power assembly of claim 6, wherein the sending coil comprises coupling arms coupled to the circuit.

8. The mobile power assembly of claim 1, wherein further comprising a port, the port is coupled to the circuit to charge or discharge the battery.

9. The mobile power assembly of claim 2, wherein the port is a Universal Serial Bus port.

10. The mobile power assembly of claim 1, wherein a control switch is coupled to the circuit.

11. The mobile power assembly of claim 1, wherein a plurality of indicators are coupled to the circuit.

12. The mobile power assembly of claim 1, wherein further comprises a frame, a first cover and a second cover sealing the battery, the circuit, the signal receiving unit and the signal sending unit in the frame.

13. The mobile power assembly of claim 12, wherein a non-skid plate is arranged on the second cover to maintain an electrical device when the electrical device is charged by the battery.

14. A mobile power assembly, comprising:
a battery coupled to a circuit;
a signal receiving unit located at a side of the battery and coupled to the circuit, the battery being charged by the signal receiving unit receiving signals;
a signal sending unit located at an opposite side of the battery and coupled to the circuit, the battery discharging by the signal sending unit sending signals;
a control switch coupled to the circuit to control the battery; and
a plurality of indicators to indicate status of the battery.

15. The mobile power assembly of claim 14, wherein further comprising a frame, a first cover and a second cover sealing the battery, the signal receiving unit, the signal sending unit, the control switch and the indicators in the frame.

16. The mobile power assembly of claim 15, wherein a first through hole is defined in the first cover to correspond to the control switch, and a plurality of second through holes are defined in the second cover to correspond to the indicators.

17. A mobile power assembly comprising:
a rechargeable battery;
a signal receiving unit;
a signal sending unit; and
a circuit board;
wherein, the circuit board is coupled to the battery, the signal receiving unit and the signal sending unit; and
wherein, the battery is rechargeable by signals received through the signal receiving unit and the battery discharges power through the signal sending unit.
